(19) United States
(12) Patent Application Publication
(10) Pub. No.: US 2016/0041937 A1
(43) Pub. Date: Feb. 11, 2016

(54) NETWORK INTERFACE CARD COUPLED TO DRIVE CARRIER

(71) Applicant: HEWLETT-PACKARD DEVELOPMENT COMPANY, L.P., Houston, TX (US)

(72) Inventors: Randol Dale Aldridge, Houston, TX (US); Isaac Lagnado, Houston, TX (US)

(21) Appl. No.: 14/776,933

(22) PCT Filed: Mar. 20, 2013
(86) PCT No.: PCT/US13/33099

§ 371 Date: Sep. 15, 2015

(51) Int. Cl. G06F 13/40; G06F 13/42

(52) U.S. Cl. CPC G06F 13/4027; G06F 13/4282

(57) ABSTRACT

An example drive carrier in accordance with an aspect of the present disclosure may he mounted within a drive bay of a computing device. A network interface card may be coupled to the drive carrier, and the network interface card may be communicatively coupled to the computing device.

### BACKGROUND

In some computing environments, a user may desire to connect a computing device to multiple types of networks, such as wired networks, wireless networks, and fiber optics networks. For each type of network, the computing device may require a network interface card specific to that type of network. A network interface card enables the computing device to connect to and communicate with a network of other computing devices.

### BRIEF DESCRIPTION OF THE DRAWINGS

The following detailed description references the drawings, in which:

FIG. 1 illustrates a network interface card coupled to a drive carrier according to examples of the present disclosure;

FIG. 2 illustrates a network interface card coupled to a drive according to examples of the present disclosure;

FIG. 3 illustrates a network interface card coupled to a drive carrier and having a connection cable according to examples of the present disclosure;

FIGS. 4A and 4B illustrate a network interface card coupled to a drive carrier according to examples of the present disclosure;

FIG. 5 illustrates a network interface card coupled to drive carrier, the drive carrier being mounted in a drive bay of a computing device, according to examples of the present disclosure; and

FIG. 6 illustrates a method for coupling a network interface card to a drive carrier according to examples of the present disclosure.

### DETAILED DESCRIPTION

Users of computing devices have expressed the desire for an additional network card, such as a fiber optics network card, to the users' computing devices. Often, these computing devices have only one port, such as a peripheral component interconnect express (PCIe) port, available for connecting network cards, graphic cards, etc., which may already be occupied. For example, if a user's computing device utilizes multiple monitors, the PCIe port may be occupied by graphics card for supporting the multiple monitors. In another example, a user's computing device may have no port for connecting a network card. Consequently, the user's computing device is unable to accommodate the addition of a network card, such as a fiber optics network card.

Various embodiments will be described below by referring to several examples of a network interface card coupled to a drive carrier. The network interface card coupled to the drive carrier provides a network connection to a computing device by communicatively coupling the network interface card to a port, such as a mini peripheral component interconnect express (PCIe) port, of the computing device. The drive carrier is mountable into a drive bay of the computing device. Contrary to current approaches, this novel and previously unforeseen approach allows computing devices without an available PCIe port to be equipped with a network card, including a fiber optics network card, by utilizing the internal mini PCIe port typically used to connect a drive such as a hard disk drive or optical drive such as a CD-ROM.

The techniques described herein may provide a number of advantages. As one example, a computing device may be equipped with both a specialty graphics card and a fiber optics network card. Alternatively, in computing devices with no PCIe port available, the computing device may be equipped with a fiber optics network card by utilizing the mini PCIe port in the computing device. Moreover, the computing device manufacturer need not design and supply an additional PCIe port to meet customer demand, thus reducing the cost of the computing device to the manufacturer and the customer. These and other advantages will be apparent from the description that follows.

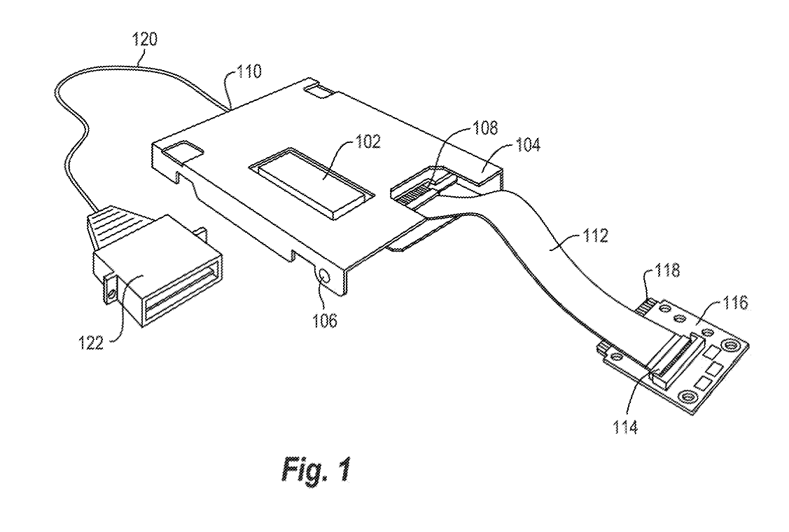

FIG. 1 illustrates an example of a network interface card 102 coupled to a drive carrier 104. In this example, the network interface card 102 is partially enclosed by the drive carrier 104, although in other embodiments the networking interface card 102 could be entirely enclosed or not enclosed. If the network interface card 102 is not partially or entirely enclosed by the drive carrier 104, the network interface card 102 may be coupled to the drive carrier 104 using coupling brackets in another example. Alternatively, the network interface card 102 may be coupled to the drive carrier 104 with glue, adhesive, solder, welding, or the like such that the network interface card 102 is adjacent to or against the drive carrier 104 but is not enclosed.

The drive carrier 104 may be of a standard size (e.g., 5.25″, 3.5′, 2.5″, 1.8″, etc.) so that it is mountable in a drive bay of a computing device. As used throughout this disclosure, a computing device may include a thin client, personal computer, laptop computer, netbook computer, server, scientific instrument, retail point of sale device, or other similar device for which network access may be desirable.

The drive carrier 104 may be mounted to the drive bay of the computing device using a screw, bolt, or similar fastening device through mount hole 106. As will become apparent, other mounting configurations are also possible.

The network interface card 102 may have a device connection port 108 for connecting a communication cable 112 to connect the network interface card 102 to a computing device. The communication cable 112 may be a flexible flat cable, a ribbon cable, or another suitable cable for communicatively connecting the network interface card 102 to a computing device,

In one example, the communication cable 112 may connect to a computing device via optional electronic circuitry. in this example, the communications cable 112 may connect to a mini PCIe connection board 116 at a connection 114. The connection 114 may be of the same type as device connection port 108 or may be of a different type. Mini PCIe connection board 116 connects via connection 118 to a mini PCIe port on a motherboard or similar electronic component of the computing system (not shown). Alternatively, the communications cable 112 may connect directly to a motherboard or similar electronic component of a computing device (not shown) without the mini PCIe connection board 116.

The network interface card 102 also includes a network connection port 110 for connecting to a network via a network cable 120. For example, a fiber optics network cable may connect to the network connection port 110 if the network interface card 102 is a fiber optics network interface card. The network cable 120 may include a network interface port 122 for connecting to the network. The network interface port 122 may be dependent upon the type of network or network interface card 102 in a particular environment and may include, for example, a Subscriber Connector (SC), a Fiber Connector (FC), a Lucent Connector (LC), a Multiple-Fiber Push-On/Pull-Off connector (MPT), an RJ-11 connector, an RJ-45 (Ethernet) connector, or other similar network connectors. Other types of network cables may connect to the network connection port 110 in other instances depending on the type of network and/or the network interface card 102 in a particular environment.

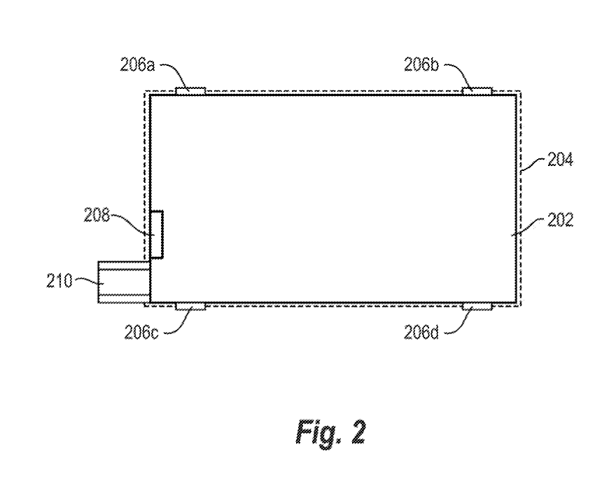

FIG. 2 illustrates an example of a network interface card 202 coupled to a drive carrier 204. In this example, the network interface card 202 is coupled to the drive carrier 204 at four coupling brackets 206a,b,c,d. The coupling brackets 206a,b,c,d of the drive carrier 204 secure the network interface card 202 to the drive carrier 204. Although four coupling brackets 206a,b,c,d are shown, a different number of coupling brackets may be utilized in different implementations. Other configurations of coupling brackets are also possible. Additionally, the coupling brackets 206a,b,c,d may be used to mount the drive carder 204 to a computing device. For example, the coupling brackets 206a,b,c,d may have a mount hole such as mount hole 106 of FIG. 1 to mount the drive carrier 204 to the computing device using a screw or similar fastening device. Alternatively, the network interface card 202 may be coupled to the drive carrier 204 directly without the use of any coupling brackets. Instead, the network interface card 202 may be glued, welded, soldered, or otherwise coupled to the drive carrier 204.

The network interface card 202 includes a device connection port 208 for connecting the network interface card 202 to a computing device via a communications cable such as a flexible flat cable, ribbon cable, or other type of electrical cable. The network interface card 202 also includes a network connection port 210 for connecting to a network via a network cable. For example, a fiber optics network cable may connect to the network connection port 210 if the network interface card 202 is a fiber optics network interface card. Other types of network cables may connect to the network connection port 210 in other instances depending on the type of network and/or the network interface card 202 in a particular environment.

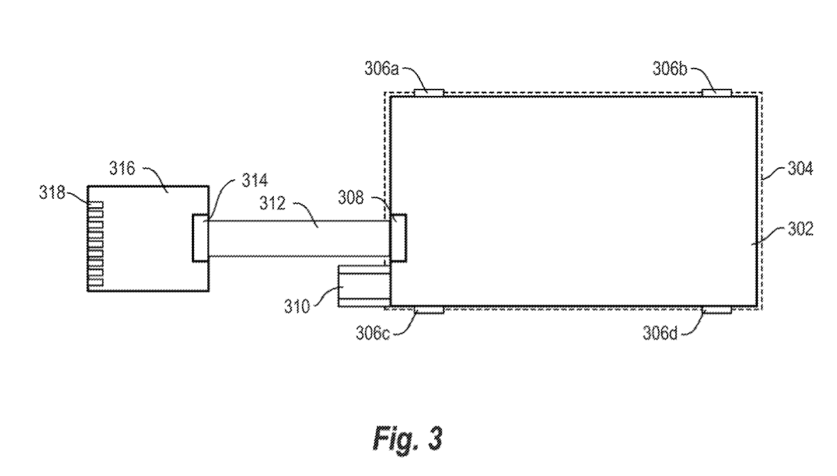

FIG. 3 illustrates an example of a network interface card 302 coupled to a drive carrier 304 and having a connection cable 312. In this example, as in FIG. 2, the network interface card 302 is coupled to the drive carrier 304 at four coupling brackets 306a,b,c,d. As discussed, the manner in which the network interface card 302 is coupled to the drive carrier 304 may vary. The network interface card 302 also includes a network connection port 310 for connecting to a network via a network cable. As in other examples, various types of network cables may be desirable depending on the type of the network and/or the network interface card 302.

The network interface card 302 also includes a device connection port 308 for connecting the network interface card 302 to a computing device via a communications cable 312, which may be a flexible flat cable, a ribbon cable, or other suitable cable. In the example shown in FIG. 3, the communications cable 312 may connect to a circuit board such as mini PCIe connection board 316 at a connection 314. The connection 314 may be of the same type as device connection port 310 or may be of a different type. The mini PCIe connection board 316 connects via connection 318 to a mini PCIe port on a motherboard or similar electronic component of the computing system (not shown). Alternatively, the communications cable 312 may connect directly to a motherboard or similar electronic component of the computing system (not shown) without the mini PCIe connection board 316.

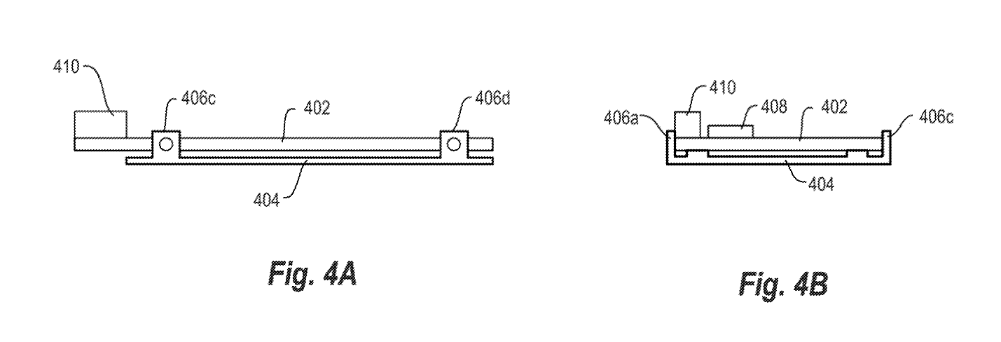

FIGS. 4A and 4B illustrate an example of a network interface card 402 coupled to a drive carrier 404. In this example, as in FIGS. 2 and 3, the network interface card 402 is coupled to the drive carrier 404 at coupling brackets 406a,b,c,d. As before, the manner in which the network interface card 402 is coupled to the drive carrier 404 may vary. For instance, in this example, network interface card 402 is mounted to the drive carrier 404 in a suspended manner such that the network interface card 402 only comes into contact with the drive carrier 404 at coupling brackets 406a,b,c,d. Alternatively, the network interface card 402 may rest adjacent to and/or on to of the drive carrier 404. Optionally, the drive carrier 404 may entirely or substantially enclose the network interface card as shown, for example, in FIG. 1.

The network interface card 402 includes a device connection port 408 for connecting the network interface card 402 to a computing device via a communications cable and a network connection port 410 for connecting to a network via a network cable, as discussed above.

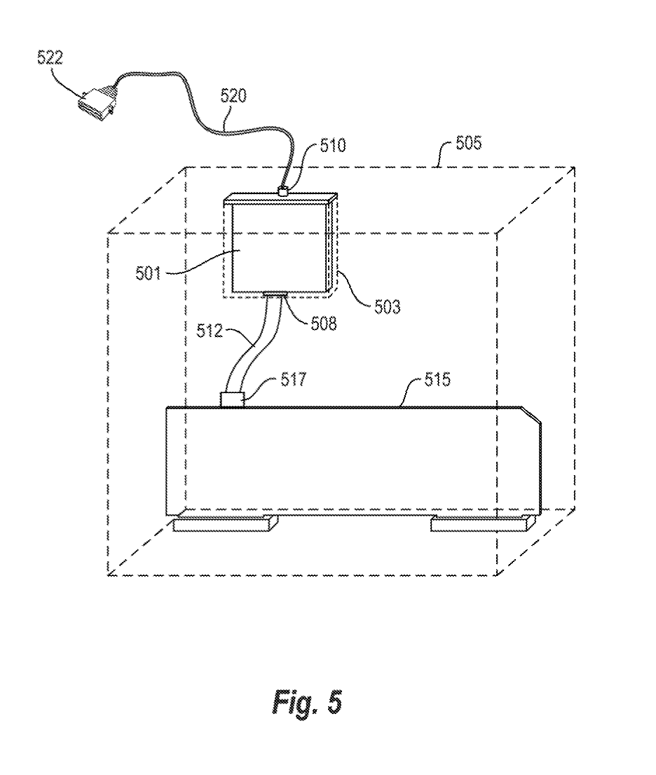

FIG. 5 illustrates an example of a network interface card coupled to a drive carrier 501 mounted in a drive bay 503 of a computing device 505. As discussed above, the computing device 505 may be a thin client, personal computer, laptop computer, netbook computer, server, science instrument, retail point of sale device, or other similar device for which network access may be desirable.

The network interface card coupled to the drive carrier 501 is also communicatively coupled to the computing device 505. More specifically, network interface card coupled to the drive carrier 505 includes a device connection port 508 for connecting a communications cable 512, such as a flexible flat cable, ribbon cable, or another type of communication cable. The communications cable 512 is also connected to a motherboard 515 or similar electronic component of computing device 505 via a motherboard port 517 on the motherboard 515. The motherboard port 517 may be, for example, a peripheral component interconnect express (PCIe) port, a mini PCIe port, or another similar type of port.

Optionally, and as discussed above, additional electronic circuitry may be desirable for connecting communication cable 512 to motherboard 515. In this optional aspect of the present disclosure, the communications cable 512 may connect to a mini PCIe connection board (not pictured) at the motherboard port 517.

The network interface card coupled to a drive carrier 501 also includes a network connection port 510 for connecting to a network via a network cable 520. For example, a fiber optics network cable may connect to the network connection port 510 if the network interface card coupled to a drive carrier 501 is a fiber optics network interface card. The network cable 520 may include a network interface port 522 for connecting to the network. As discussed herein, the network interface port 522 type may vary and may depend upon the type of network or network interface card in a particular environment.

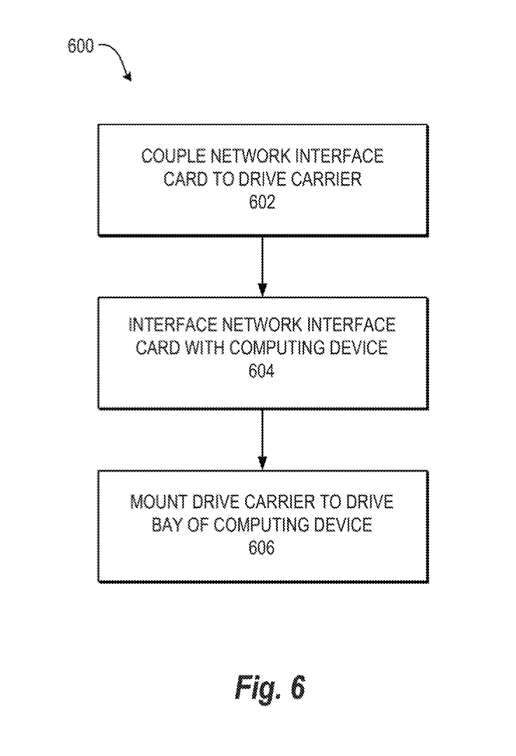

FIG. 6 illustrates an example of a method 600 of installing a network interface card into a computing device. Specifically, the example method 600 includes coupling a network interface card to a drive carder (block 602), interfacing the network interface card with a computing device (block 604), and mounting the drive carrier into a drive bay of the computing device (block 606). Additional processes also may be included, and it should be understood that the processes depicted in FIG. 6 represent generalized illustrations, and that other processes may be added or existing processes may be removed, modified, or rearranged without departing from the scope and spirit of the present disclosure.

At block 602, a network interface card is coupled to a drive carrier. For instance, the network interface card may be coupled inside of, and fully or partially enclosed by, the drive carrier as shown in FIG. 1. Alternatively, the network interface card may be coupled to the drive carder such that the network interface card remains substantially exposed and is merely coupled to the side of the drive carrier and as shown in FIGS. 4A and 4B. Other possible coupling arrangements are also possible.

At block 604, the network interface card is interfaced with a computing device. The interfacing may be accomplished by communicatively coupling the network interface card to the computing device. For example, the network interface card may be communicatively coupled to a motherboard or similar electronic component of the computing device by connecting a communication cable between the network interface card and a port on the motherboard or similar electronic component of the computing device. The port on the motherboard or similar electronic component may include a peripheral component interconnect express (PCIe) port, a mini PCIe port, or another similar type of port, for example. Optionally, additional electronic circuitry may be desirable to connect the communication cable to the motherboard or similar electronic component of the computing device. The communication cable may be a flexible flat cable, ribbon cable, or other similar type of communication cable.

At block 606, the drive carrier is mounted into a drive bay of the computing device. In one example, the drive carrier may be mounted to the drive bay of the computing device by affixing the drive carrier to the drive with a fastener such as a screw, bolt, clip, or other similar fastener. In another example, the drive carrier may include a drive caddy, drive rails, or another type of mechanism for mounting the drive carrier into the drive bay. Optionally, the drive carrier may be welded, soldered, glued, or similarly mounted into the drive bay of the computing device.

It should be emphasized that the above-described embodiments are merely possible examples of implementations, set forth for a clear understanding of the principles of the present disclosure. Many variations and modifications may be made to the above-described examples without departing substantially from the spirit and principles of the present disclosure. Further, the scope of the present disclosure is intended to cover any and all combinations and sub-combinations of all elements, features, and aspects discussed above. All such modifications and variations are intended to be included within the scope of the present disclosure, and all possible claims to individual aspects or combinations of elements or steps are intended to be supported by the present disclosure.

What is claimed is:

1. A system comprising:
a drive carrier to be mounted within a drive bay of a computing device; and
a network interface card coupled to the drive carrier, wherein the network interface card is communicatively coupled to a mini peripheral component interconnect express (PCIe) port of the computing device via a flexible flat cable.

2. The system of claim 1, further comprising a circuit board, wherein the circuit board interconnects with the flexible flat cable and a mother board of the computing device.

3. The system of claim 2, wherein the circuit board is a connection: board.

4. The system of claim 1, wherein the network interface card comprises a fiber optics network interface card.

5. The system of claim 4, wherein the fiber optics network interface card further comprises a subscriber connector.

6. A system comprising:
a computing device having a drive bay and a mini peripheral component interconnect express (PCIe) port;
a drive carrier mountable within the drive bay of the computing device; and
a network interface card coupled to the drive carrier, wherein the network interface card is communicatively coupled to the mini PCIe port of the computing device.

7. The system of claim 6, wherein the network interface card is communicatively coupled to the mini PCIe port of the computing device via a flexible flat cable.

8. The system of claim 7, further comprising a circuit board, wherein the circuit board interconnects with the flexible flat cable and the mini PCIe port of the computing device.

9. The system of claim 8, wherein the circuit board is a mini PCIe connection board.

10. The system of claim 6, wherein the network interface card comprises a fiber optics network interface card.

11. The system of claim 10, wherein the fiber optics network interface card further comprises a subscriber connector.

12. A method comprising:
coupling a network interface card to a drive carrier;
interfacing the network interface card with a computing device by communicatively coupling the network interface card to a mini peripheral component interconnect express (PCIe) port of the computing device; and
mounting the drive carrier into a drive bay of the computing device.

13. The method of claim 12, wherein communicatively coupling the network interface card to the mini PCIe port of the computing device further comprises communicatively coupling the network interface card to the mini PCIe port of the computing device via a flexible flat cable.
